(19) United States
(12) Patent Application Publication
(10) Pub. No.: US 2005/0283991 A1
(43) Pub. Date: Dec. 29, 2005

(54) Two-stage apparatus for the removal of moisture from a gas flow and insert for same

(76) Inventor: John Robert McKenzie, Raymond (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/874,165

(22) Filed: Jun. 24, 2004

(51) Int. Cl. F26B 21/06; F26B 3/00

(52) U.S. Cl. 34/80; 34/82

(57) ABSTRACT

A gas dryer or condenser utilizes a two-stage insert, each stage containing a different moisture-removing material such as a combination of lava rock, gravel and a felt material, housed within a pressure vessel, to dry a stream of gas, such as air from an air compressor. Moisture-laden compressed air passing through sequentially through each of the two stages releases liquid in the air onto the surfaces of the materials and the separated liquid drains into a liquid collection area in the bottom of the pressure vessel.

### FIELD OF THE INVENTION

The invention relates generally to apparatus for removing small amounts of liquids from a gas stream and more particularly to the removal of moisture from compressed gases such as air.

### BACKGROUND OF THE INVENTION

Downstream condensation can be a serious problem for equipment which rely upon a source of compressed air that contains even relatively small amounts of moisture for their operation.

Typically, for use in drying gas flows in other industries such as the oil and gas industry, simple centrifugal separator vessels are implemented which are capable of gross removal but result in substantial moisture or liquid re-entrainment. Dehydrators are applied for the removal of water vapor from hydrocarbon gas streams. Dehydrators, such as those implementing glycol, are capable of greater moisture removal, however they are also associated with a large cost and negative environmental impact including a large energy cost associated with heating to separate water and glycol and the exhaust emissions. Such systems are too large and costly to be applied for use in most commercially available compressed air systems, and particularly those employed by the trades to operate air-powered tools or the like.

More often, compressed air systems for use with tools are equipped with nothing at all to deal with moisture problems or are equipped with pressure vessels filled with dessicant materials which act to remove and accumulate the moisture in the pore spaces of the dessicant material. Typically, the systems are regenerative and have two dessicant filled pressure vessels fluidly connected to the compressed air source. As the desiccant in one pressure vessel becomes saturated with liquid removed from the compressed air, the system is switched to the second pressure vessel. The first pressure vessel is then regenerated by driving the moisture from the dessicant using heat, blowers and the like. Such systems are also relatively expensive and require a source of energy to power the regeneration system.

Applicant has determined that there is a novel and simple approach to the removal of liquids from gas flows, such as compressed air, which demonstrates improved efficiency without the need for costly regenerative systems and additional energy consumption and which can be retrofit to existing compressed air systems.

### SUMMARY OF THE INVENTION

Apparatus are applied for the removal of liquids from gas streams including compressed air.

A two-stage apparatus is provided for better liberating liquid from such gas streams so as to prevent downstream condensation in tools and the like, connected to the compressed air source.

In one broad aspect the present invention comprises a pressure vessel for receiving the gas stream having an inlet at a top end, an outlet adjacent the top end and a liquid collection zone in a bottom end; a first stage adapted to be suspended in the pressure vessel above the liquid collection zone and having a bore, at least a portion of which is filled with a first moisture-removing material forming a tortuous pathway though which the gas stream passes, moisture being collected on a surface of the first moisture-removing material and flowing co-current with the gas stream, the liquid flowing to the liquid collection zone; and a second stage containing a second moisture-removing material for receiving a substantially drier gas stream from the first stage and removing residual moisture therefrom, the moisture being condensed to liquid which flows counter-current to the gas stream therein, the liquid flowing to the liquid collection zone and the substantially drier gas stream flowing to the gas outlet.

In a second broad aspect the present invention comprises an insert, adapted to be suspended in a pressure vessel having cylindrical side walls, a bottom end, and gas inlet adjacent a top end, the insert comprising: a tubular first stage adapted to be suspended in the pressure vessel above the liquid collection zone and having a bore filled with a first moisture-removing material forming a tortuous pathway though which the gas stream may pass, moisture being condensed on a surface of the first moisture-removing material and flowing concurrent with the gas stream, the liquid flowing to the liquid collection zone; and a second stage formed in an annulus between the tubular first stage and the pressure vessel and containing a second moisture-removing material for receiving a substantially drier gas stream from the first stage and removing residual moisture therefrom, the moisture being condensed to liquid which flows counter-current to the gas stream therein, the liquid flowing to the liquid collection zone and the substantially drier gas stream flowing to the gas outlet.

Applicant believes that moisture droplets are separated from the gas stream by the principles of impingement separation wherein liquid droplets or mist coalesce on the surface of the particulate or fiberous material and drain therefrom. Re-entrainment of the liquid into the gas flow is substantially prevented by the velocity of the gas stream, and the lack of contact of the gas stream with the separated liquids by diverting the flow of substantially dried gas away from the liquid collection zone in the bottom of the separator.

Preferably, use of a moisture transporting material, such as gravel, in the bore of the first stage below the first moisture-removing material, aids in more quickly removing liquids from the moisture-removing material and transporting the liquids to the liquid collection zone.

Natural materials may be used as the moisture-removing materials and particularly, lava rock and felt material which have large surface areas with tortuous and narrow passages through which the gas stream is directed for separation of liquids from the gas therein.

The two-stage apparatus advantageously requires no regeneration of the moisture-removing materials and can be sized to accommodate the desired flow rates and to suit the relative humidity of the incoming gas stream.

### BRIEF DESCRIPTION OF THE DRAWINGS

FIG. 1 is a longitudinal sectional view of an embodiment of a two-stage condenser apparatus having an insert according to an embodiment of the invention fit or retrofit therein;

FIG. 2 is a partial sectional view of a mist distributor for distributing moisture-laden gas as a mist into a first stage of the insert according to FIG. 1;

FIG. 3 is a plan view of the insert according to FIG. 1;

FIG. 4 is a plan view of a top plate of the insert according to FIG. 1; and

FIG. 5 is a plan view of a bottom plate of the insert according to FIG.

### DETAILED DESCRIPTION OF THE PREFERRED EMBODIMENT

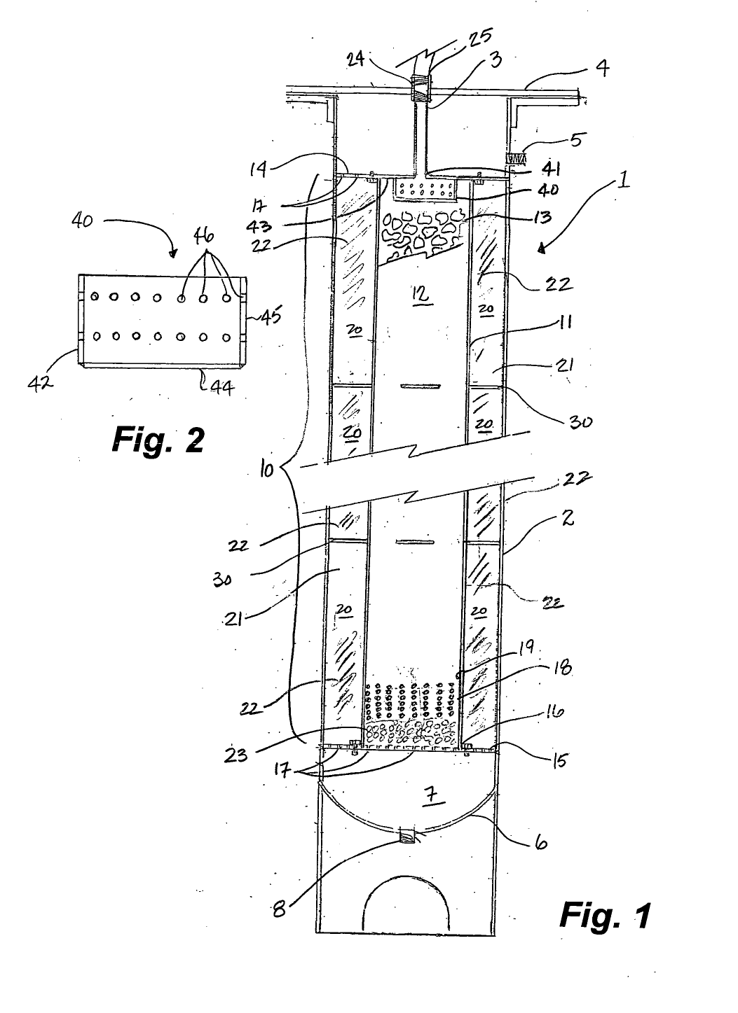

Having reference to FIG. 1, a two-stage condenser or gas dryer 1, according to an embodiment of the invention, is shown. Typically, in use, the two stage condenser 1 is connected downstream from a compressed gas source (not shown), such as an air compressor, and upstream from apparatus (not shown), such as air-powered tools, to prevent downstream condensation from occurring in the connected apparatus.

The condenser 1 comprises an outer vessel 2, typically a pressure certified vessel. The vessel 2 has an inlet 3 at a top end 4 for admitting a flow of moisture-laden compressed gas under pressure, typically air, and an outlet 5, adjacent the vessel's top end 4 for releasing a flow of substantially moisture-free compressed gas therefrom. The inlet 3 is fluidly connected to an insert 10 suspended within the vessel 2. The insert 10 comprises a tubular first stage 11 having a central bore 12, a portion of which is filled with a first moisture-removing material 13 which has a large surface area and forms a plurality of surfaces and tortuous pathways therebetween capable of collecting moisture droplets thereon for removing moisture from the gas stream. The tubular first stage 11 is suspended above a bottom 6 of the vessel 2 creating a liquid collection zone 7 at the bottom of the vessel. As the moisture laden gas is flowed through the first moisture-removing material 13, moisture droplets are retained on the surface of the material 13, where the droplets are coalesce into a liquid flow which flows co-current with the gas, carried by the velocity of the flow and by gravity, to the bottom 6 of the vessel 2.

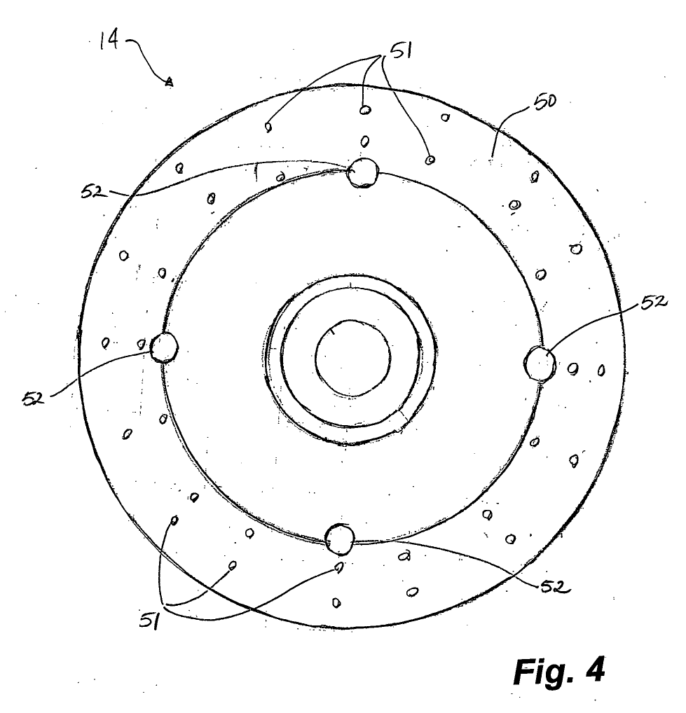

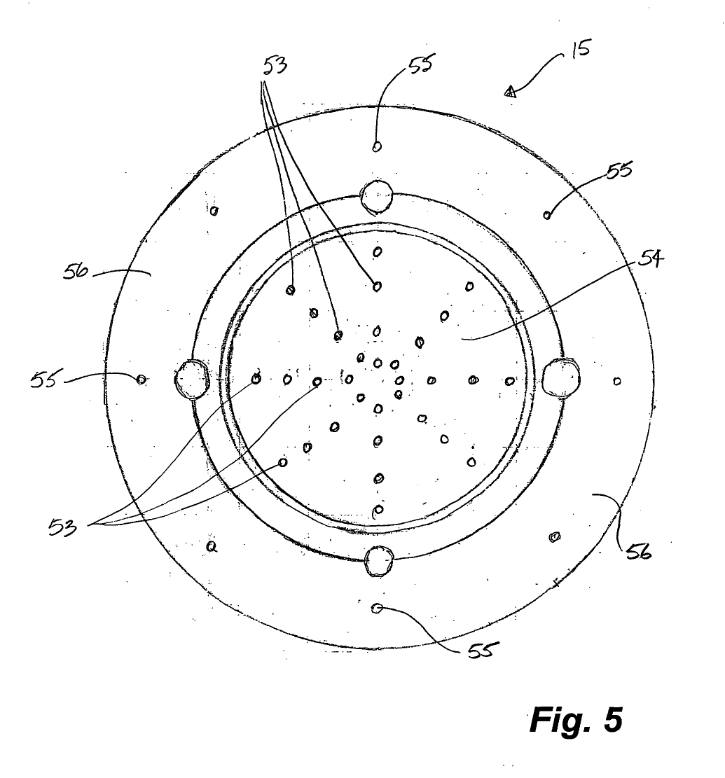

A top plate 14 (FIG. 4), positioned adjacent the outlet 5 at the top 4 of the vessel 2 and a bottom plate 15 (FIG. 5) positioned at a base 16 of the tubular first stage 11, are fastened to the tubular first stage 11 and act to retain the first moisture-removing material 13 within the central bore 12. A plurality of perforations 17 are formed in both the top 14 and bottom 15 plates to permit the flow of gas and liquid therethrough.

Further, a plurality of perforations 18 are formed about a sidewall 19 of the tubular first stage 11, adjacent and above the bottom plate 15, to permit the flow of gas from the first stage 11 of the condenser 1 to a second stage 20 of the condenser 1, situated in an annulus 21 formed between the tubular first stage 11 and the vessel 2. Gas, having had a large portion of the liquid removed, flows from the tubular first stage 11 outwards through the sidewall perforations 18 and upwards into the second stage 20 of the condenser 1, while heavier coalesced liquid droplets, removed in the first stage 11, drain to the liquid collecting zone 7. A drain 8 in the bottom 6 of the liquid collecting zone 7 is used to remove accumulated liquids from the condenser 1.

The second stage 20 of the condenser 1 is filled with a second moisture-removing material 22. Gas flowing upward through the second moisture-removing material 22 releases a substantial portion of any residual moisture droplets retained therein. As the gas continues to rise, the collected liquids flow counter-current to the gas flow, gravity causing the liquid to flow downwards through the perforations 17 in the bottom plate 15 and into the liquid collection zone 7. Substantially dry gas flows from the second stage 20 of the condenser 1 to the gas outlet 5 adjacent the top 4 of the vessel 2.

In one embodiment of the invention, the first moisture-removing material 13 is a particulate material which when packed in the bore 12 has a large surface area and the ability to collect and coalesce liquid droplets from the gas as it passes through the tortuous pathways between the particulates and subsequently permits the coalesced liquid to flow therethrough. It is believed that the liquid is separated from the gas stream by the principles of impingement separation wherein liquid droplets or mist coalesce on the surface of the particulate material 13 and drain therefrom with minimum to no re-entrainment of the liquid into the gas flow.

Typically, in impingement separation, re-entrainment is prevented by the velocity of the gas flow, the ratio of the liquid to the gas and preventing the gas from contacting the liquid once separated. In the case of the present invention, the velocity of the gas flow in the pressure vessel 2 is maximized by the velocity of the input from the compressor and the restricted nozzle-like inlet 3. Moisture in the compressed gas flow is minimized as much as possible through conventional compressor technology and the gas flow is prevented from contacting the larger volumes of collected liquid in the liquid collection zone 7 by diverting the flow of the substantially dried gas outwards through the sidewall perforations 18 of the first stage 11 substantially above the liquid collection zone 7. Advantageously, regeneration of the moisture-removing materials is not required, as the interaction at the surface does not alter or exhaust the materials ability to remove liquids, over time.

Examples of the first moisture-removing material 13 are broken solids such as brick, tile, rock and stone and further include, gravel and lava rock, lava rock being preferred. In the case where lava rock is used as the first moisture-removing material 13, a layer of gravel 23 is placed at the base 16 of the first stage 11, below the lava rock and adjacent the sidewall perforations 18 of the tubular first stage 11 and the bottom plate 15 to aid in transporting liquid collected on the lava rock 13 to the liquid collection zone 7. In an embodiment of the invention, the layer of lava rock 13 is approximately 6 inches, the remainder of the central bore 12 being filled with gravel 23.

The second moisture-removing material 22 is a relatively finer pore material than the first moisture-removing material 13 to ensure remaining moisture in the gas flow is contacted as it passes therethrough to ensure maximum collection and moisture removal. One such material 22 is a felt material, preferably a fine density felt material. It is believed that, much like conventional fiber mist eliminators, the felt, a randomly oriented fiber bed having tortuous and narrow pathways formed therethrough, acts to collect droplets on the fibers by inertial impaction and direct interception, while even smaller droplets are collected on the fibers by brownian diffusion. As the droplets coalesce into larger droplets, the larger droplets are flowed by gravity, counter-current to the gas flow, and to the liquid collection zone 7.

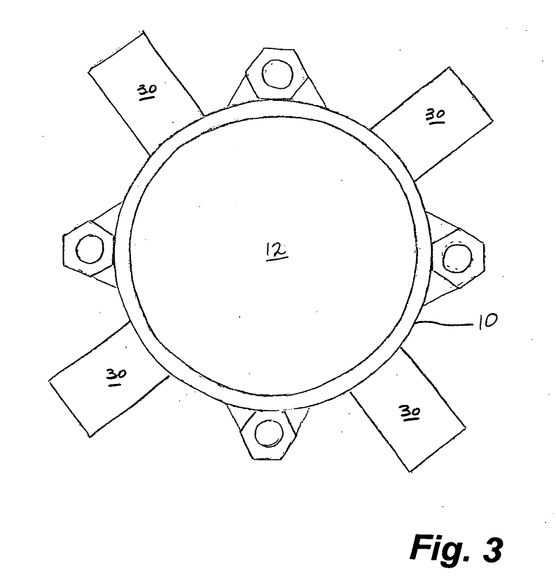

As shown in FIGS. 1 and 3, dividers 30 are connected between the insert 10 and the vessel 2 at intervals throughout the annulus 21 to ensure the second moisture-removing material 22 is kept in place in the second stage 20.

The insert 10, including the top and bottom plates 14,15, can be manufactured from corrosion resistant materials such as stainless steel, galvanized steel, PCV plastic, ABS plastic or the like.

Having reference to FIGS. 1 and 2, the inlet 3 is typically a pipe connected to a port 24 in a top 4 of the vessel 2 which is connected, at an outside end 25, to a gas compressor (not shown). The insert 10 is suspended in the vessel 2, typically by threading the inlet pipe 3 into the port 24 in the top 4 of the vessel 2. Further, the inlet 3 extends through the top plate 14 and is connected to a mist distributor 40 at an inside end 41. The mist distributor 40 is fluidly connected to the inlet 3 and positioned beneath the top plate 14, in the bore 12 of the first stage 11. The mist distributor 40 acts to ensure that moisture in the gas flow is formed into mist prior to loading the gas flow into the first stage 11 of the insert 10 to ensure optimal contact of the moisture with the material therein.

As shown in greater detail in FIG. 2, one embodiment of the mist distributor 40 comprises a circular housing 42 which is adapted to be fastened to an underside 43 of the top plate 14, fluidly connected to the inside end 41 of inlet pipe 3 and having a solid bottom plate 44 and a perforated sidewall 45. Moisture-laden gas, from a compressor (not shown), entering the mist distributor 40 through the restricted inlet 3 has a significant velocity, which causes the entrained moisture to strike the bottom plate 44 and deflect through the perforations 46 in the sidewall 45, creating a mist which is subsequently carried through the first stage 11 by the velocity of the gas flow, as well as by gravity.

While typically used in a vertical configuration, the condenser 1 of the present invention is also operable in a substantially prone position, provided the condenser 1 is positioned at a slight angle, preferably not less than 4 degrees, to permit drainage. In a prone configuration, liquids released as a result of condensation in both the first 11 and second 20 stages fall to the sidewall 19 of the tubular first stage 11 or the sidewall of the pressure vessel 2 respectively and flow therealong to the liquid collection area 7.

Embodiments of the insert 10 of the invention may be manufactured separately for use to retrofit pre-manufactured pressure vessels 2, which are already pressure certified, to make condensers 1 according to embodiments of the present invention. Alternatively, the complete condenser 1 including the pressure vessel 2 and the insert 10 may be manufactured and subsequently be pressure certified. The size of the condenser 1 may be customized for the use to which it is to be put, taking into consideration the pressure, the flow rates of gas produced by the compressor, the flow rate required downstream and the initial humidity of the gas 6 flow.

### EXAMPLE 1

As shown in FIG. 1, a 48 inch long, prior art, certified pressure vessel having a diameter of approximately 8 inches was used to house a 36 inch long insert 10 according to an embodiment of the invention. The insert 10 was suspended from the inlet 3 such that a liquid collection zone 7 of approximately 8 inches was formed below the bottom plate 15 and a space of approximately 4 inches was formed between the top 4 of the pressure vessel 2 and the top plate 14 of the insert 10. The gas outlet 5 was located in the pressure vessel 2, approximately 1 inch above the top plate 14. Dividers 30, shown in FIG. 3, were connected to the first stage 11 at 12 inch intervals above the bottom plate 15 to support ½″ to 2″ thick layers of felt material 22 therebetween. The dividers 30 were 1″×1×⅛″ plates connected between the sidewall 19 of the tubular first stage 11 and the vessel 2. The perforations 18 in the sidewall 19 of the tubular first stage 11 are about ¼ inch in diameter and are located in a 2 inch band about the circumference of the first stage 11, extending from approximately 2 inches to approximately 4 inches above the bottom plate 15. A 2 inch layer of gravel 23 is positioned at the base 16 of the first stage 11, the remainder of the bore 12 being filled with lava rock 13.

The mist distributor 40 is a 2″ pipe, approximately ¾ inch long and having a double row of ⅜ inch holes formed therebout. The inlet pipe 3 is a 1 inch pipe extending from the top 4 of the vessel 2 to the top plate 14 where it is fluidly connected to the mist distributor 40 position therebeneath.

As shown in FIG. 4, an outer portion 50 of the top plate 14 is perforated with 32⅜ inch holes 51 which coincide with the annulus 21 of the insert 10 to permit dry gas flowing upwards through the annulus 21 to pass through to the gas outlet 5. The reminder of the top plate 14, save holes 52 provided for bolting to the tubular first stage 11, is solid, acting to cover the mist distributor 40.

Having reference to FIG. 5, the bottom plate 15 is perforated with a plurality of ⅜ inch drain holes 53, predominately in a central portion 54 adjacent the base 16 of the first stage 11 to permit liquids to drain through to the liquid collection zone 7 situated below. Holes 55 are also formed about a periphery 56 to permit any liquids draining from the second stage 20 to enter the liquid collection zone 7.

In use, the condenser 1, connected to an air compressor operating at approximately 160 psi with an output of approximately 35 cfm, produced approximately 16 oz of liquid every 5 days, consistently reducing the relative humidity of the compressed air from 23% to 8% and sometimes as low as 6%.

### EXAMPLE 2

A small, one horsepower air compressor was connected to a condenser according to an embodiment of the invention, the compressor being operated for approximately 2 hours. The output of the compressor was approximately 7.5 cfm and the moisture output, while small at only 8-10 drops over the two hour period, was sufficient to drop the relative humidity of the air from an input relative humidity of approximately 23% to an output relative humidity of approximately 10%.

Application of the apparatus disclosed herein results in significant savings over known drier technology and significantly improves performance and life of tools where a small, economical gas dryer was not previously available.

1. Apparatus for treating a gas stream containing liquid, the apparatus comprising:
a pressure vessel for receiving the gas stream having a port at a top end, an outlet adjacent the top end and a liquid collection zone in a bottom end;
a first stage adapted to be suspended in the pressure vessel above the liquid collection zone and having a gas inlet fluidly connected to a bore filled with a first moisture-removing material forming a tortuous pathway though which the gas stream passes, moisture being collected on a surface of the first moisture-removing material and flowing co-current with the gas stream, the liquid flowing to the liquid collection zone; and
a second stage containing a second moisture-removing material for receiving a substantially drier gas stream from the first stage and removing residual moisture therefrom, the moisture being condensed to liquid which flows counter-current to the gas stream therein, the liquid flowing to the liquid collection zone and the substantially drier gas stream flowing to the gas outlet.

2. The apparatus as described in claim 1 wherein the first moisture-removing material is a particulate material.

3. The apparatus as described in claim 1 wherein the second moisture-removing material is a fiber material.

4. The apparatus as described in claim 2 wherein the first moisture-removing material is a selected from the group consisting of broken brick, broken tile, and pieces of rock, stone, gravel and lava rock.

5. The apparatus as described in claim 2 wherein the first moisture-removing material is lava rock.

6. The apparatus as described in claim 3 wherein the second moisture-removing material is a felt material.

7. The apparatus as described in claim 1 further comprising:
an insert being suspended within the pressure vessel above the liquid collection zone and fluidly connected to the inlet for forming the tubular first stage and forming an annulus therebetween, the annulus forming the second stage, the insert further comprising a top plate and a bottom plate for supporting the tubular first stage and first and second moisture-removing materials therebetween, the top and bottom plates being perforated to permit the passage of gas and liquids therethrough.

8. The apparatus as described in claim 7 further comprising a mist distributor fluidly connected to the inlet and positioned in the bore of the first stage for distributing the gas stream containing liquid to the insert as a mist.

9. The apparatus as described in claim 7 further comprising a plurality of dividers positioned in the annulus between the insert and the pressure vessel for retaining the second moisture-removing material therein.

10. The apparatus as described in claim 7 further comprising a plurality of perforations in a sidewall of the tubular first stage adjacent a base for permitting gas having had a substantial portion of liquid removed to flow from the first stage to the second stage, above the liquid collection zone.

11. The apparatus as described in claim 5 further comprising a layer of gravel adjacent a base of the tubular first stage,

12. An insert for treating a gas stream containing liquid, the insert being adapted to a pressurized vessel having cylindrical side walls, a bottom end, and port in a top end, the insert comprising:
a tubular first stage adapted to be suspended in the pressure vessel above the liquid collection zone and having gas inlet fluidly connected to a bore filled with a first moisture-removing material forming a tortuous pathway though which the gas stream may pass, moisture being condensed on a surface of the first moisture-removing material and flowing concurrent with the gas stream, the liquid flowing to the liquid collection zone; and
a second stage formed in an annulus between the tubular first stage and the pressure vessel and containing a second moisture-removing material for receiving a substantially drier gas stream from the first stage and removing residual moisture therefrom, the moisture being condensed to liquid which flows counter-current to the gas stream therein, the liquid flowing to the liquid collection zone and the substantially drier gas stream flowing to the gas outlet.

13. The insert as described in claim 12 wherein the first moisture-removing material is a particulate material.

14. The insert as described in claim 12 wherein the second moisture-removing material is a fiber material.

15. The insert as described in claim 13 wherein the first moisture-removing material is a selected from the group consisting of broken brick, broken tile, and pieces of rock, stone, gravel and lava rock.

16. The insert as described in claim 13 wherein the first moisture-removing material is lava rock.

17. The insert as described in claim 14 wherein the second moisture-removing material is a felt material.

18. The insert as described in claim 12 further comprising a top plate and a bottom plate for supporting the tubular first stage and first and second moisture-removing materials therebetween, the top and bottom plates being perforated to permit the passage of gas and liquids therethrough.

19. The insert as described in claim 12 further comprising a mist distributor fluidly connected to the inlet and positioned in the bore of the first stage for distributing the gas stream containing liquid to the insert as a mist.

20. The insert as described in claim 12 wherein the insert is suspended from the gas inlet.

21. The insert as described in claim 12 further comprising a plurality of dividers positioned in the annulus between the insert and the pressure vessel for retaining the second moisture-removing material therein.

22. The insert as described in claim 12 further comprising a plurality of perforations in a sidewall of the tubular first stage adjacent a base for permitting gas having had a substantial portion of liquid removed to flow from the first stage to the second stage, above the liquid collection zone.

23. The insert as described in claim 16 further comprising a layer of gravel adjacent a base of the tubular first stage.
